(19) United States
(12) Patent Application Publication
(10) Pub. No.: US 2015/0220188 A1
(43) Pub. Date: Aug. 6, 2015

(54) SCREEN CAPABLE OF VARYING DISPLAY AREA, MOBILE TERMINAL AND SCREEN DISPLAY METHOD THEREOF

(71) Applicant: HUIZHOU TCL MOBILE COMMUNICATION CO., LTD., HUIZHOU, GD (CN)

(72) Inventor: Shiqing Zhao, Huizhou (CN)

(73) Assignee: HUIZHOU TCL MOBILE COMMUNICATION CO., LTD, HUIZHOU (CN)

(21) Appl. No.: 14/422,508

(22) PCT Filed: Apr. 16, 2014
(86) PCT No.: PCT/CN2014/075447

§ 371 Date: Feb. 19, 2015

(30) Foreign Application Priority Data
Jul. 2, 2013 (CN) 201310274068.4

(51) Int. Cl. G06F 3/041; G09G 3/36; G06F 3/044; G06F 3/045; G06F 1/16; G06F 3/0488

(52) U.S. Cl. CPC G06F 3/0412; G06F 1/1622; G06F 1/1652; G06F 3/04883; G06F 3/044; G06F 3/045; G09G 3/36; G06F 2200/1612; G06F 2203/04101; G06F 2203/04808; G09G 2380/02

(57) ABSTRACT

The present disclosure relates to a screen capable of varying a display area, a mobile terminal that incorporates an associated screen and a method of varying a display area of a screen display thereof. A screen capable of varying a display area, that is arranged on a mobile terminal, includes a main screen, a rolling screen capable of being rolled into a cylinder, a rolling screen rotating shaft for controlling rolling and/or unrolling of the rolling screen, and a rolling screen sensor for detecting a size of an unrolled area of the screen. The main screen may be arranged on a front of the mobile terminal. Two rolling screens may be included, which may be arranged at a respective side of the main screen, and one side edge of each rolling screen may be connected with the main screen.

### TECHNICAL FIELD

The present disclosure relates to display screen technologies. In particular, the present disclosure relates to a screen capable of varying a display area, a mobile terminal including an associated screen, and a method for varying a display area of an associated screen.

### BACKGROUND

Due to rapid development of semiconductor technologies, electronic components and parts used by portable mobile terminals, such as cell phones, tablets, etc., are highly integrated, have increasingly small sizes and occupy very small space in cell phones and tablets. In addition, the electronic components and parts have increasingly high compatibility and universality, and most functions are the same for cell phones and tablet computers. Currently, cell phones and tablet computers have different screen sizes, which, to a great extent, determine a purchase inclination and use demand of associated users. For example, due to a relatively small screen size of a smartphone, the smartphone is easily carried around, and is often used for making phone calls, taking photos and reading novels. Due to relatively big screen sizes, on the other hand, tablet computers are more suitable for browsing webpages, playing games and watching TV.

Along with improved living standards, and requirements of work and life, many users often own cell phones and tablet computers at the same time. The cell phone is convenient for communication and the tablet computer is used for entertainment. To carry these two types of mobile terminals at the same time, it is also necessary to carry associated accessories, such as batteries, data cables and chargers. As a result, weight carried is increased, and it is relatively inconvenient to place and retrieve the data cable. Due to different needs, purchase of both a cell phone and a tablet computer will increase a user's consumption cost and, at the same time, an associated data plan fee for using the cell phone and tablet computer will increase correspondingly.

Therefore, the prior art needs to be improved.

### SUMMARY

In light of the above shortcomings of the prior art, the object of the present invention is to provide a screen capable of varying a display area, a mobile terminal including an associated display, and a method of varying a size of a screen display, which can vary a size of the display area such that one mobile terminal can be used as mobile terminals of different models and sizes. As a result, a screen capable of varying a display area expands a mobile terminal's compatibility.

To attain the above objectives, the present invention employs the following technical solutions:

A screen capable of varying a display area, that is arranged on a mobile terminal, includes a main screen, a first rolling screen capable of being rolled into a cylinder, a first rolling screen rotating shaft for controlling rolling and/or unrolling of the first rolling screen, and a first rolling screen sensor for detecting a size of an unrolled area of the first screen; and a second rolling screen capable of being rolled into a cylinder, a second rolling screen rotating shaft for controlling rolling and/or unrolling of the second rolling screen, and a second rolling screen sensor for detecting a size of an unrolled area of the second screen, wherein the main screen is arranged on a front of the mobile terminal, and each rolling screen is arranged at a respective side of the main screen, a first side edge of the first rolling screen is connected with a first side of the main screen, a first side edge of the second rolling screen is connected with a second side of the main screen, the first rolling screen rotating shaft is fixedly connected to a second side edge of the first rolling screen, the second rolling screen rotating shaft is fixedly connected to a second side edge of the second rolling screen, the first rolling screen sensor is arranged on the first rolling screen, and the second rolling screen sensor is arranged on the second rolling screen.

In another embodiment, a screen capable of varying a display area includes a rolling screen that is formed integrally with the main screen.

In a further embodiment, a screen capable of varying a display area includes a conducting layer for implementing a touch function when a back of a rolling screen is in contact with a touch screen, wherein the conducting layer is arranged on the back of the rolling screen.

In yet a further embodiment, a screen capable of varying a display area includes a conducting layer that is made of either a conductor material or a semi-conductor material.

In another embodiment, a screen capable of varying a display area includes a fixing and supporting layer for rolling and/or unrolling a rolling screen to a preset position, and for keeping the rolling screen flat and stretched, wherein the fixing and supporting layer is arranged between a back of the rolling screen and the conducting layer.

In a further embodiment, a screen capable of varying a display area includes a fixing and supporting layer that is made of a rigid material.

In yet a further embodiment, a screen capable of varying a display area includes a fixing and supporting layer that is either aluminum foil or tin foil.

In another embodiment, a screen capable of varying a display area that is arranged on the mobile terminal includes a main screen and a rolling screen that both include a flexible display screen and a flexible touch screen, wherein the flexible touch screen is disposed above the flexible display screen, and wherein the touch screen is either a capacitive touch screen or a resistive touch screen.

In a further embodiment, a mobile terminal includes a CPU; a display module; and a second rolling screen capable of being rolled into a cylinder, a second rolling screen rotating shaft for controlling rolling and/or unrolling of the second rolling screen, and a second rolling screen sensor for detecting a size of an unrolled area of the second screen, wherein the CPU connects the screen and the display module for identifying a size of a current screen display area, and wherein the display module implements display driving, according to the screen size identified by the CPU, such that a displayed image is displayed to a full screen of the current screen display area.

A method for varying a display area of a mobile terminal includes detecting in real-time, using a rolling screen sensor, a touch value when a back of a rolling screen is in contact with a touch screen; transmitting the touch value to a CPU; calculating, using the CPU, a size of a display area of a current screen according to the touch value; transmitting the calculated size of the display area to the display module; and adjusting, using the display module, display drive parameters according to the calculated size of the display area, such that pixels, in a display interface, are spread evenly in the display area.

Compared with the prior art, the present invention provides a screen capable of varying a display area, a mobile terminal including an associated screen and a method of varying a size of an association screen. The screen includes a main screen, a first rolling screen capable of being rolled into a cylinder, and a second rolling screen capable of being rolled into a cylinder each rolling screen is arranged at a respective side of the main screen, a first side edge of the first rolling screen is connected with a first side of the main screen, a first side edge of the second rolling screen is connected with a second side of the main screen, the first rolling screen rotating shaft is fixedly connected to a second side edge of the first rolling screen, the second rolling screen rotating shaft is fixedly connected to a second side edge of the second rolling screen, the first rolling screen sensor is arranged on the first rolling screen, and the second rolling screen sensor is arranged on the second rolling screen.

### BRIEF DESCRIPTION OF THE DRAWINGS

FIG. 1 illustrates a rolled mobile terminal having a screen capable of varying a display area according to the present invention;

FIG. 2 illustrates an unrolled mobile terminal having a screen capable of varying a display area according to the present invention;

FIG. 3 illustrates that a back of a rolling screen is in contact with a touch screen according to an embodiment of the present invention; and

FIG. 4 is a flow chart of a method for varying a size of a screen display area of a mobile terminal according to an embodiment of the present invention.

### DETAILED DESCRIPTION

The present invention provides a screen capable of varying a display area, a mobile terminal that includes an associated screen and a method of varying a size of a display area of an associated screen. To make the objectives, technical solutions, and effects of the present invention clearer and more specific, the present invention is described in detail with reference to the accompanying drawings, and exemplary embodiments. It should be understood that the specific embodiments described herein are for illustrative purposes. The specific embodiments, described herein, are not intended to limit the scope of the present invention in any way.

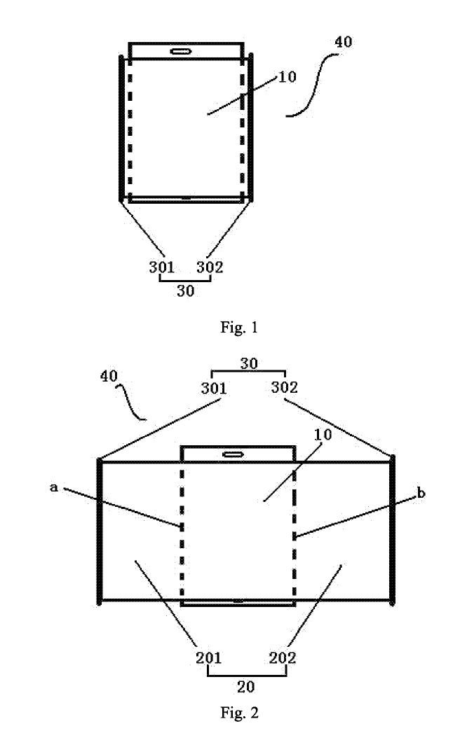

Turning to FIG. 1 and FIG. 2, a screen capable of varying a display area may be arranged on a mobile terminal 40, and may include a main screen 10, rolling screens 20 capable of being rolled into cylinders, rolling screen rotating shafts 30 for controlling the rolling or unrolling of the rolling screens 20, and a rolling screen sensor (not shown) for detecting a size of the unrolled area of a respective screen. The main screen 10 may be arranged on a front of the mobile terminal 40. For example, the main screen 10 may be arranged on the front of the mobile terminal 40 in a position where a customary screen of a mobile terminal is positioned. The screen capable of varying a display area may include a left rolling screen 201 and a right rolling screen 202, as depicted in FIG. 2. A first and second rolling screen may be arranged at two sides, i.e., left and right sides, of the main screen 10, respectively. One side edge of the rolling screen 20 may be connected with the main screen 10. For example, a left rolling screen 201 may be connected with the left side of the main screen 10, and a right rolling screen 201 may be connected with the right side of the main screen 10. The screen capable of varying a display area may include a left rolling screen rotating shaft 301 and a right rolling screen rotating shaft 302. The left rolling screen rotating shaft 301 may be fixedly connected to a side edge of the left rolling screen 201. The right rolling screen rotating shaft 302 may be fixedly connected to a side edge of the right rolling screen 202. The rolling screen sensor may be arranged on the rolling screen 20.

It should be understood that a screen of a mobile terminal may consist of a display screen and a touch screen. The touch screen may be arranged above the display screen, which may be any known type of a transparent absolute positioning system. The screens according to the present invention, i.e. the main screen and the rolling screens, all may consist of a flexible LCM (LCD Module, Liquid Crystal Display Module) display screen and a flexible touch panel touch screen, and the flexible touch screen may be disposed above the flexible display screen. The touch screen may be either a capacitive touch screen or a resistive touch screen. In such a way, both the main screen and the rolling screens can implement the functions of display and touch, and have flexibility, and may be easy to be rolled.

In order to make a displayed image, on rolling screens 20 and the main screen 10, continuous, the rolling screens 20 may be formed integrally with the main screen 10. In other words, a connection “a”, between the left rolling screen 201 and the left side of the main screen 10, and the connection “b”, between the right rolling screen 201 and the right side of the main screen 10, may be continuous without a connection seam, and the rolling screens 20 and the main screen 10 may define a single plane. In such a way, images at connections between the rolling screens 20 and the main screen 10 may not have a splicing effect, and the image may include continuity and integrity.

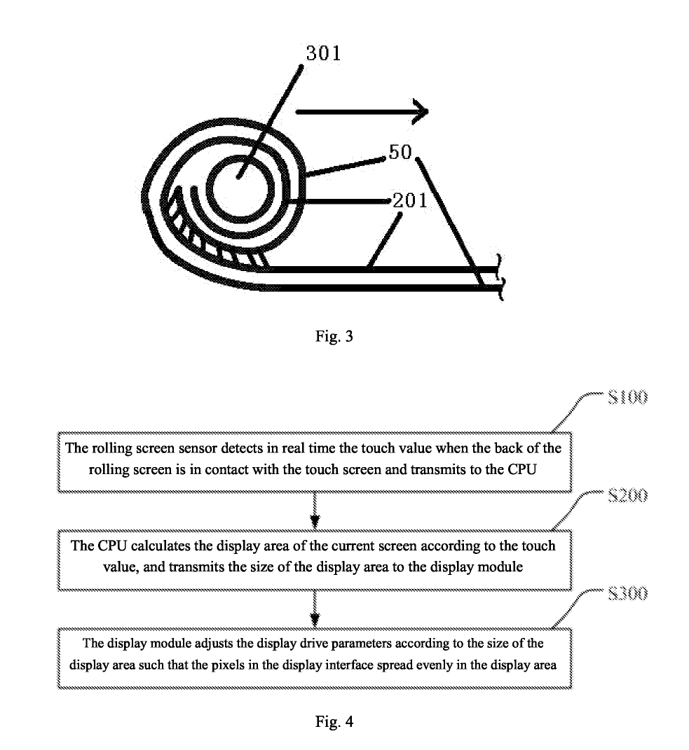

In order to detect a size of an unfolded screen, an amount of the rolling screens 20 that has been rolled may be determined. In particular, a conducting layer 50 may be arranged on a back of a rolling screen 20, as shown in FIG. 3, when the back of the rolling screen is in contact with a touch screen. Thereby, the conducting layer 50 can implement a touch function, which may be equivalent to a finger touching a touch screen. In response to a touch on the screen, a corresponding touch capacitance or touch resistance may be formed. The rolling screen sensor may detect a value of the touch capacitance or touch resistance, and may transmit the touch value to a CPU (Central Processing Unit) of the mobile terminal. The CPU may determine a screen size based on the touch value. The rolling screen sensor may be arranged on the rolling screens 20, which may be similar to an arrangement of sensors in known touch screens, thus, will not be described in detail herein.

The conducting layer 50 may use a material that can simulate human hand properties, such as a conductor material or a semi-conductor material. This material may be evenly coated on a back of the rolling screen 20 to form the conducting layer 50. Furthermore, the back of the rolling screen may be in contact with the touch screen, which may entail the conducting layer 50 being in contact with the touch screen. Since the conductive material can simulate human hand properties, when a human hand touches the touch screen, the conductive material may include a touch capacitor of certain capacitance or a touch resistor of certain resistance. The value of the touch capacitor or the touch resistor may be continuous in a touch range. Based on a value of the touch capacitor or the touch resistor detected by a rolling screen sensor, the CPU can determine what parts of the rolling screens 20 are rolled.

It should be understood that when the rolling screens 20 are rolled, a part of the conducting layer 50 may be exposed. One example is when the left rolling screen 201 is rolled, as the side view shown in FIG. 3. For the purpose of illustration, there is a gap shown between the left rolling screen rotating shaft 301, the left rolling screen 201 and the conducting layer 50 in FIG. 3 when, in fact, these three components are closely attached to each other. A touch capacitor or a touch resistor may be formed when a conducting layer 50 is in contact with the left rolling screen 201 (equivalent to a touch screen), as shown by the shaded area in FIG. 3. When the left rolling screen rotating shaft 301 continues to rotate toward a direction shown in FIG. 3, the left rolling screen 201 may be rolled, a contact area between the conducting layer 50 and the left rolling screen 201 may be increased, and an area of the left rolling screen 201, that can display images, may be decreased. When the left rolling screen rotating shaft 301 rotates opposite to the direction shown in FIG. 3, the left rolling screen 201 may be unrolled, the contact area between the conducting layer 50 and the left rolling screen 201 may be decreased, and the area of the left rolling screen 201 that can display images may be increased.

The conducting layer 50 may use a conducting rubber. In such a way, it can both achieve an effect of a human hand touching a touch screen, and may protect a back of the rolling screen 20. In particular, the part of the rolling screen 20, exposed during rolling, may be protected. Thereby, the rolling screen may avoid external pollution and/or scratches, for example, stains left when a human hand touches the back of the rolling screen 20, and scratches due to friction with other objects when, for example, placed in a bag, etc.

In order to roll or unroll the rolling screens 20 to a preset position, i.e. a position desired by a user, to make the rolling screen rotating shafts 30 fixed and stationary, and to keep the rolling screens 20 flat and stretched, a fixing and supporting layer may be arranged between a back of the rolling screen 20 and a conducting layer. The fixing and supporting layer may be, for example, made of a rigid material, and may use aluminum foil or tin foil. Thus, the rolling screens 20 may be flexible and can be rolled, and may only be rolled or unrolled with certain strength, such that the rolling screen rotating shafts 30 can be fixed at a position desired by a user. The rolling screens 20 and the touch screen may be closely attached, and may not get loose. Furthermore, an unrolled part of the rolling screens 20 can maintain a flat status without issues of sagging or tilting downward.

It should be understood that, in addition to being unrolled laterally or rolled as shown in FIG. 2, the rolling screens 20 may also be arranged on top and bottom sides or four sides, top, down, left and right, of a mobile terminal 40. A diameter of the rolling screen rotating shafts 30 may be greater than a thickness of the rolling screens 20.

A mobile terminal may include a CPU, a display module and a screen capable of varying a display area. As shown in FIG. 1 and FIG. 2, the main screen 10 may be arranged on a front of the mobile terminal 40. The rolling screens 20 and the rolling screen rotating shafts 30 may extend out of the mobile terminal 40. The rolling screens 20 may be unrolled or rolled by rotating the rolling screen rotating shafts 30, thereby, varying a size of a display area of the mobile terminal 40. When the rolling screens 20 are rolled, a back of the rolling screen may contacts the a touch screen to produce a touch capacitor or a touch resistor. When the rolling screen sensor detects a value of a touch capacitance or a touch resistance, the touch value may be transmitted to a CPU. The CPU may connect the screen and a display module for identifying a size of a current screen according to the touch value detected by the rolling screen sensor. The display module may implement display driving according to the screen size identified by the CPU, such that a displayed image may be displayed to a full screen of the current display area.

A method of varying a size of a screen may include detecting in real-time, using a rolling screen sensor, a touch value when a back of a rolling screen is in contact with a touch screen (block S100). The touch value may be transmitted to a CPU (block S100). The CPU may calculate a display area of a current screen according to the touch value (block S200). The size of the display area may be transmitted to a display module (block S200). The display module may adjust display drive parameters according to the size of the display area, such that pixels, in a display interface, are spread evenly in the display area (block S300).

When the touch screen is a capacitive touch screen, the touch value may be a touch capacitance. When the touch screen is a resistive touch screen, the touch value may be a touch resistance. The principle of the production of a touch value, and a touch value quantity may be similar to known principles. It should be noted that a touch value produced may be continuous, as the contact area between a back of a rolling screen and a touch screen may be one continuous piece, and a part of the touch screen shielded by the back of the rolling screen may not display images. As a result, the CPU can calculate a display area of a current screen according to a detected touch value. The display module may adjust display drive parameters in real time according to a current size of a display area, such that a display interface may occupy a full screen of the display area.

In summary, a screen capable of varying a display area, a mobile terminal including an associated screen, and a method of varying a size of an associated screen are provided. A screen may be unrolled and/or rolled, and a display interface may be automatically adjusted to an optimal size for display. When the rolling screens of the screen are fully rolled, the mobile terminal may be used as a cell phone. When the rolling screens are unrolled, the mobile terminal may be used as a cell phone or tablet computer of different sizes. A proper screen size may be selected according to different requirements, which may make it easy for a user to carry and use the mobile terminal, and may expand the mobile terminal's compatibility. In addition, a display effect of both a cell phone and a tablet computer can be enjoyed on the same mobile terminal, which may greatly reduce the cost, and may enhance fun and operability.

It should be understood that to those skilled in the art, equivalent substitutions or modifications may be made according to the technical solutions of the present invention, and all of these substitutions or modifications shall be encompassed by the scope of the appended claims.

1. A screen capable of varying a display area that is arranged on a mobile terminal, the screen comprising: a main screen, a first rolling screen capable of being rolled into a cylinder, a first rolling screen rotating shaft for controlling rolling and/or unrolling of the first rolling screen, and a first rolling screen sensor for detecting a size of an unrolled area of the first screen; and
a second rolling screen capable of being rolled into a cylinder, a second rolling screen rotating shaft for controlling rolling and/or unrolling of the second rolling screen, and a second rolling screen sensor for detecting a size of an unrolled area of the second screen,
wherein the main screen is arranged on a front of the mobile terminal, and each rolling screen is arranged at a respective side of the main screen, a first side edge of the first rolling screen is connected with a first side of the main screen, a first side edge of the second rolling screen is connected with a second side of the main screen, the first rolling screen rotating shaft is fixedly connected to a second side edge of the first rolling screen, the second rolling screen rotating shaft is fixedly connected to a second side edge of the second rolling screen, the first rolling screen sensor is arranged on the first rolling screen, and the second rolling screen sensor is arranged on the second rolling screen.

2. The screen according to claim 1, wherein at least one rolling screen is formed integrally with the main screen.

3. The screen according to claim 1, further comprising: a conducting layer for implementing a touch function when a back of a respective rolling screen is in contact with a touch screen, wherein the conducting layer is arranged on the back of the respective rolling screen.

4. The screen according to claim 3, wherein the conducting layer is made of either a conductor material or a semi-conductor material.

5. The screen according to claim 3, further comprising: a fixing and supporting layer for rolling and/or unrolling at least one rolling screen to a preset position, and for keeping the at least one rolling screen flat and stretched, wherein the fixing and supporting layer is arranged between the back of the at least one rolling screen and the conducting layer.

6. The screen according to claim 5, wherein the fixing and supporting layer is made of a rigid material.

7. The screen according to claim 6, wherein the fixing and supporting layer is either aluminum foil or tin foil.

8. The screen according to claim 1, wherein
the main screen, the first rolling screen, and the second rolling screen include a respective flexible display screen and a respective flexible touch screen, the respective flexible touch screen is disposed above the respective flexible display screen, and the respective touch screen is either a capacitive touch screen or a resistive touch screen.

9. The screen according to claim 8, wherein at least one rolling screen is formed integrally with the main screen.

10. The screen according to claim 8, further comprising: at least one conducting layer for implementing the touch function when the back of the respective rolling screen is in contact with the respective touch screen, wherein the at least one conducting layer is arranged on the back of the respective rolling screen.

11. The screen according to claim 10, wherein the at least one conducting layer is made of either a conductor material or a semi-conductor material.

12. The screen according to claim 10, it further comprising: at least one fixing and supporting layer for rolling and/or unrolling a respective rolling screen to a preset position, and for keeping the respective rolling screen flat and stretched, wherein the at least one fixing and supporting layer is arranged between the back of the respective rolling screen and the at least one conducting layer.

13. The screen according to claim 12, wherein the at least one fixing and supporting layer is made of a rigid material.

14. The screen according to claim 1, wherein the at least one fixing and supporting layer is either aluminum foil or tin foil.

15. A mobile terminal, comprising:
a CPU;
a display module; and
a second rolling screen capable of being rolled into a cylinder, a second rolling screen rotating shaft for controlling rolling and/or unrolling of the second rolling screen, and a second rolling screen sensor for detecting a size of an unrolled area of the second screen, wherein the CPU connects the screen and the display module for identifying a size of a current screen display area, and wherein the display module implements display driving, according to the screen size identified by the CPU, such that a displayed image is displayed to a full screen of the current screen display area.

16. A screen display method for varying a display area of a mobile terminal according to claim 15, the method comprising:
detecting in real-time, using a rolling screen sensor, a touch value when a back of a rolling screen is in contact with a touch screen,
transmitting the touch value to a CPU;
calculating, using the CPU, a size of a display area of a current screen according to the touch value;
transmitting the calculated size of the display area to the display module; and
adjusting, using the display module, display drive parameters according to the calculated size of the display area such that pixels, in a display interface, are spread evenly in the display area.

17. The mobile terminal according to claim 15, further comprising: at least one conducting layer for implementing a touch function when a back of the respective rolling screen is in contact with a respective touch screen, wherein the at least one conducting layer is arranged on the back of the respective rolling screen.

18. The mobile terminal according to claim 17, wherein the at least one conducting layer is made of either a conductor material or a semi-conductor material.

19. The method according to claim 16, further comprising:
providing at least one fixing and supporting layer for rolling and/or unrolling a respective rolling screen to a preset position, and for keeping the respective rolling screen flat and stretched, wherein the at least one fixing and supporting layer is arranged between the back of the respective rolling screen and the at least one conducting layer.

20. The method according to claim 19, wherein the at least one fixing and supporting layer is made of a rigid material.
